(19) United States
(12) Patent Application Publication
(10) Pub. No.: US 2024/0195479 A1
(43) Pub. Date: Jun. 13, 2024

(54) MAXIMUM PERMISSIBLE EXPOSURE (MPE) MITIGATION FOR MULTI-PANEL USER EQUIPMENT (UE)

(71) Applicant: LENOVO (BEIJING) LIMITED, Beijing (CN)

(72) Inventors: Bingchao LIU, Beijing (CN); Lianhai WU, Beijing (CN); Hongmei LIU, Beijing (CN); Haiming WANG, Beijing (CN)

(21) Appl. No.: 18/553,084

(22) PCT Filed: Mar. 31, 2021
(86) PCT No.: PCT/CN2021/084264

§ 371 Date: Sep. 28, 2023

(51) Int. Cl. H04B 7/06; H04W 52/36

(52) U.S. Cl. CPC H04B 7/0691; H04W 52/365

(57) ABSTRACT

Methods and apparatuses for maximum permissible exposure (MPE) mitigation for multi-panel UE are disclosed. In one embodiment, a method of a UE is disclosed. The UE has multiple panels, wherein one or more of the multiple panels are activated. The method comprises associating a panel ID with each of the activated panel(s); and reporting one or more P-MPR values corresponding to the one or more activated panels in response to MPE event(s) being detected on the one or more activated panels.

### FIELD

The subject matter disclosed herein generally relates to wireless communications, and more particularly relates to methods and apparatuses for maximum permissible exposure (MPE) mitigation for multi-panel UE.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Power management Maximum Power Reduction (P-MPR), maximum permissible exposure (MPE), Power Headroom Report (PHR), Medium Access Control (MAC), MAC control element (MAC CE), logical channel ID (LCID), power headroom (PH), uplink shared channel (UL-SCH), Physical Uplink Shared Channel (PUSCH), Physical Uplink Control Channel (PUCCH), (E-UTRA), eNB NR Dual Connection (EN-DC), NR eNB Dual Connection (NE-DC), NG (Next Generation)-eNB NR Dual Connection (NGEN-DC), Sounding Reference Signal (SRS), frequency range 2 (FR2): indicating a frequency range of 24.25 GHz-52.6 GHz, frequency range 1 (FR1): indicating a frequency range of 450 MHz-6 GHz, Multiple panel UE (multi-panel UE, or MP-UE), transmission reception point (TRP), multiple TRP (multi-TRP or M-TRP), channel state information reference signal (CSI-RS), CSI-RS resource indicator (CRI), quasi co-location (QCL), quasi co-located (QCLed), synchronization signal (SS), physical broadcast channel (PBCH), SS/PBCH block indicator (SSBRI), information element (IE), Transmission Configuration Indication (TCI), band width part (BWP), TS (Technical Specification) (TS refers to 3GPP Technical Specification in this disclosure).

A UE can configure its maximum output power P_{CMAX,f,c} for carrier f of a serving cell c. However, to ensure compliance with applicable electromagnetic power density exposure requirements (e.g. in the condition that proximity detection is used to address such requirements that require a lower maximum output power) and to address unwanted emissions and/or self-defense requirements, the UE has to reduce its maximum output power. A reduction to the maximum output power is applied. The reduction to the maximum output power (which is achieved by the power management maximum power reduction (P-MPR)) means a power to be reduced from the maximum output power. When a measured P-MPR_{f,c} for carrier f of a serving cell c is equal to or larger than a pre-configured threshold (e.g. an event triggered threshold (configured by higher layer parameter mpe-Threshold)), if a prohibit timer (e.g. mpe-ProbibitTimer) expires or has expired, an MPE (maximum permissible exposure) event is detected. It means that P-MPR (e.g. P-MPR_{f,c}) is equal to or larger than a maximum permissible reduction to the maximum output power. When the MPE event is detected, a P-MPR reporting is triggered. In the P-MPR reporting, an absolute P-MPR value shall be reported to the base station (e.g. gNB).

The absolute P-MPR value is reported from the UE to the base station by sending a Single Entry PHR MAC CE or a Multiple Entry PHR MAC CE. The Single Entry PHR MAC CE is identified by a MAC subheader with a dedicated LCID as specified in FIG. 1.

The Single Entry PHR MAC CE has a fixed size and consists of two octets defined as follows:
R: Reserved bit, set to 0.
Power Headroom (PH): This field indicates the power headroom level. The length of the field is 6 bits. The reported PH and the corresponding power headroom levels are shown in Table 1 (the corresponding measured values in dB are specified in 3GPP Technical Specification TS 38.133 V16.3.0). TS is an abbreviation for Technical Specification, and refers to 3GPP Technical Specification in the following description.

TABLE 1

| PH | Power Headroom Level |
|---|---|
| 0 | POWER_HEADROOM_0 |
| 1 | POWER_HEADROOM_1 |
| 2 | POWER_HEADROOM_2 |
| 3 | POWER_HEADROOM_3 |
| . . . | . . . |
| 60 | POWER_HEADROOM_60 |
| 61 | POWER_HEADROOM_61 |
| 62 | POWER_HEADROOM_62 |
| 63 | POWER_HEADROOM_63 |

Power Headroom (PH) has three types:

Type 1 power headroom: it refers to the difference between the nominal UE maximum transmit power and the estimated power for UL-SCH (uplink shared channel) transmission per activated serving cell. Type 1 power headroom for an activated serving cell may be calculated based on a reference PUSCH transmission. For example, a UE may be configured with multiple PUSCH power control parameter sets each of which has an index j. When close loop power control is enabled for the UE, two PUSCH power control adjustment states, each of which has a index l, are supported. For PUSCH transmission occasion i on active UL BWP b of carrier f of serving cell c, if the PUSCH is transmitted using PUSCH power control parameter set configuration with index j and PUSCH power control adjustment state with index l, the UE computes the Type 1 power headroom as

PH_{type1,b,f,c}(i,j,q_{d},l)=\tilde{P}_{CMAX,f,c}(i)−{P_{O_PUSCH,b,f,c}(j)+α_{b,f,c}(j)·PL_{b,f,c}(q_{d})+f_{b,f,c}(i,l)} [dB]

wherein, \tilde{P}_{CMAX,f,c}(i) is computed assuming MPR (which is allowed maximum power reduction)=0 dB, A-MPR (which is additional maximum power reduction)=0 dB, P-MPR=0 dB, and ΔT_{C} (which is allowed operating band edge transmission power relaxation)=0 dB, where MPR, A-MPR, P-MPR and ΔT_{C} are defined in TS 38.101-1 V16.3.0, TS 38.101-2 V16.3.0 and TS 38.101-3 V16.3.0; the remaining parameters are defined in Clause 7.1.1 of TS 38.213 V16.3.0, where P_{O_PUSCH,b,f,c,}(j) and α_{b,f,c} (j) are obtained using P_{O_NOMINAL_PUSCH,f,c}(0) and p0-PUSCH-AlphaSetId=0; PL_{b,f,c}(q_{d}) is obtained using pusch-PathlossReferenceRS-Id=0; and l=0.

Type 2 power headroom: it refers to the difference between the nominal UE maximum transmit power and the estimated power for UL-SCH and PUCCH transmission on SpCell of the other MAC entity (i.e. E-UTRA MAC entity in EN-DC (eNB NR Dual Connection), NE-DC (NR eNB Dual Connection), and NGEN-DC (Next Generation eNB NR Dual Connection) cases).

Type 3 power headroom: it refers to the difference between the nominal UE maximum transmit power and the estimated power for SRS (Sounding Reference Signal) transmission per activated Serving Cell. Type 3 power headroom for an activated serving cell may be calculated based on a reference SRS transmission. For example, for SRS transmission occasion i on UL BWP b of carrier f of serving cell c, and if the UE is not configured for PUSCH transmissions on UL BWP b of carrier f of serving cell c and a SRS resource for the reference SRS transmission is provided by higher layer parameter SRS-Resource, the UE computes a Type 3 power headroom report as

PH_{type3,b,f,c}(i,qₛ)=\tilde{P}_{CMAX,f,c}(i)−{P_{O_SRS,b,f,c}(qₛ)+α_{SRS,b,f,c}(qₛ)·PL_{b,f,c}(q_{d})+h_{b,f,c}(i)} [dB]

wherein, qₛ is an SRS resource set corresponding to SRS-ResourceSetId=0 for UL BWP b; P_{O_SRS,b,f,c}(qₛ), α_{SRS,f,c}(qₛ), PL_{b,f,c}(q_{d}) and h_{b,f,c}(i) are defined in Clause 7.3.1 of TS 38.213 V16.3.0 with corresponding values obtained from SRS-ResourceSetId=0 for UL BWP b; \tilde{P}_{CMAX,f,c}(i) is computed assuming MPR=0 dB, A-MPR=0 dB, P-MPR=0 dB and ΔT_{C}=0 dB, where MPR, A-MPR, P-MPR and ΔT_{C} are defined in TS 38.101-1 V16.3.0, TS 38.101-2 V16.3.0 and TS 38.101-3 V16.3.0.

P: If a higher layer parameter mpe-Reporting-FR2, which is used to enable the MPE detection, is configured and the serving cell operates on FR2, the MAC entity shall set this field to 0 if the applied P-MPR value, to meet MPE requirements, as specified in TS 38.101-2 V16.3.0, is less than P-MPR_00 as specified in TS 38.133 V16.3.0 and to 1 otherwise. If mpe-Reporting-FR2 is not configured or the serving cell operates on FR1, this field indicates whether power backoff is applied due to power management. The MAC entity shall set the P field to 1 if the corresponding P_{CMAX,f,c} field would have had a different value if no power backoff due to power management had been applied.

P_{CMAX,f,c}: This field indicates the P_{CMAX,f,c} used for calculation of the preceding PH field. The reported P_{CMAX,f,c} and the corresponding nominal UE transmit power levels are shown in Table 2 (the corresponding measured values in dBm are specified in TS 38.133 V16.3.0).

TABLE 2

| P_{CMAX, f, c} | Nominal UE transmit power level |
|---|---|
| 0 | PCMAX_C_00 |
| 1 | PCMAX_C_01 |
| 2 | PCMAX_C_02 |
| . . . | . . . |
| 61 | PCMAX_C_61 |
| 62 | PCMAX_C_62 |
| 63 | PCMAX_C_63 |

MPE: If mpe-Reporting-FR2 is configured, and the serving cell operates on FR2, and if the P field is set to 1, this field indicates the applied power backoff (i.e. the absolute P-MPR value) to meet MPE requirements, as specified in TS 38.101-2 V16.3.0. This field indicates an index to Table 3 and the corresponding measured values of P-MPR levels in dB are specified in TS 38.133 V16.3.0. The length of the field is 2 bits. If mpe-Reporting-FR2 is not configured, or if the Serving Cell operates on FR1, or if the P field is set to 0, R bits are present instead.

TABLE 3

| MPE | Measured P-MPR value |
|---|---|
| 0 | P-MPR_00 |
| 1 | P-MPR_01 |
| 2 | P-MPR_02 |
| 3 | P-MPR_03 |

As a whole, the MPE field of the PHR MAC CE can be used to report the absolute P-MPR value when an MPE event is detected. The reporting of the absolute P-MPR value can be referred to as P-MPR reporting.

The above-described P-MPR reporting is sufficient for single-panel UE in single-TRP scenario. However, it is insufficient for multiple panel UE (multi-panel UE, i.e. MP-UE) that means UE equipped with multiple panels, especially for the UE that has multiple activated panels that can be used for UL transmission. Because MPE event may happen (be detected) on any of the activated panels, and the power management status of each of the activated panels should be known for gNB for potential panel switching for UL scheduling, the above-described P-MPR reporting should be enhanced.

This disclosure targets mitigating maximum permissible exposure (MPE) for multi-panel UE, especially in FR2.

### BRIEF SUMMARY

Methods and apparatuses for maximum permissible exposure (MPE) mitigation for multi-panel UE are disclosed.

In one embodiment, a method of a UE is disclosed, the UE has multiple panels, wherein one or more of the multiple panels are activated. The method comprises associating a panel ID with each of the activated panel(s); and reporting one or more P-MPR values corresponding to the one or more activated panels in response to MPE event(s) being detected on the one or more activated panels.

In one embodiment, in response to the MPE event being detected on the activated panel selected for current UL transmission or for the latest UL transmission, only one P-MPR value is reported

In another embodiment, in response to the MPE event being detected on any of the activated panels that can be used for UL transmission, P-MPR value(s) corresponding to all activated panel(s) on each of which the MPE event is detected are reported. In this condition, the method may further comprise reporting panel ID(s) of the activated panel(s) on each of which the MPE event is detected. The Panel ID(s) may be represented by a bitmap in a MAC CE containing the P-MPR value(s), and each bit of the bitmap indicates whether the P-MPR value corresponding to the represented panel is reported.

In some embodiment, the method may further comprise reporting a power headroom for an activated panel on which the MPE event is not detected. The power headroom may be a type-1 PH calculated with a reference PUSCH transmission for the activated panel on which the MPE event is not detected for a UL cell with PUSCH transmission. In the calculation of the type-1 PH, P_{O-PUSCH,b,f,c}(j) and α_{b,f,c}(j) are obtained using P_{O_NORMAL_PUSCH,f,c}(0) and p0-PUSCH-AlphaSetID with the lowest ID associated with the activated panel on which the MPE event is not detected, and PL_{b,f,c}(q_{d}) is obtained using pusch-PathlossReferenceRS-Id with the lowest ID associated with the activated panel on which the MPE event is not detected. The power headroom may alternatively be a type-3 PH calculated with a reference SRS transmission for the activated panel on which the MPE event is not detected for a UL cell without PUSCH transmission. In the calculation of the type-3 PH, qₛ is an SRS resource set corresponding to SRS-ResourceSetId with lowest ID associated with the the activated panel on which the MPE event is not detected, P_{O_SRS,b,f,c}(qₛ), α_{SRS,f,c}(qₛ), PL_{b,f,c}(q_{d}) are obtained from SRS-ResourceSetId with lowest ID associated with the activated panel on which the MPE event is not detected.

In some embodiment, the panel ID may be identified by a CRI group ID, an SSBRI group ID, an SRS resource set ID, an UL TCI state group ID, or a joint TCI state group ID. In addition, the method may further comprise associating any of panel-specific parameters for UL transmission with the panel ID.

In another embodiment, a UE has multiple panels, wherein one or more of the multiple panels are activated. The UE comprises a processor that associates a panel ID with each of the activated panel(s); and a transmitter that reports one or more P-MPR values corresponding to the one or more activated panels in response to MPE event(s) being detected on the one or more activated panels.

In one embodiment, a method at a base unit comprises associating a panel ID with each of the activated panel(s) of a UE, wherein the UE has multiple panels, and one or more of the multiple panels are activated; and receiving one or more P-MPR values corresponding to the one or more activated panels. It is assumed that MPE event is detected on each of the activated panels.

In yet another embodiment, a base unit comprises a processor that associates a panel ID with each of the activated panel(s) of a UE, wherein the UE has multiple panels, and one or more of the multiple panels are activated; and a receiver that receives one or more P-MPR values corresponding to the one or more activated panels. It is assumed that MPE event is detected on each of the activated panels.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates a Single Entry PHR MAC CE;

FIG. 2 illustrates a multi-TRP scenario with multi-panel UE;

FIG. 3 is a schematic flow chart diagram illustrating an embodiment of a method;

FIG. 4 is a schematic flow chart diagram illustrating a further embodiment of a method; and

FIG. 5 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

For a multiple panel UE (MP-UE, i.e. a UE equipped with multiple panels), each panel includes a set of antenna ports, e.g., SRS antenna ports and/or PUSCH antenna ports. One or more of the multiple panels can be activated for DL reception and/or UL transmission. However, only one activated panel can be used for UL transmission at one time instant.

For MP-UE in multi-TRP scenario in FR2, each panel is served by a TRP. The propagation links between each panel and the served TRP are different. So, an MPE event may happen independently among each of the activated panels. Therefore, P-MPR reporting should be made for each panel.

Similar to the MPE event described in the background part, for the MPE event happened in scenario of multiple panels, an event triggered threshold (e.g. configured by a higher layer parameter mpe-Threshold) and a prohibit timer (i.e. configured by a higher layer parameter mpe-ProbibitTimer) can be configured for the MPE event for each activated panel. In particular, for an activated panel, when the measured P-MPR_{f,c} for carrier f of a serving cell c is equal to or larger than the event triggered threshold (e.g. mpe-Threshold), if the prohibit timer expires or has expired, an MPE event is detected for the activated panel.

### 1. Identifying a UE Panel:

To implement per-panel P-MPR reporting, each panel shall be identified. For example, each panel can be identified by or associated with a panel ID.

As the panel can be defined from DL or UL perspective, the panel ID can be also defined from DL or UL perspective.

According to a first embodiment of identifying a UE panel, IDs of different CRI (CSI-RS resource indicator) groups corresponding to different RX panels are used as the panel ID. Different CRIs can be used for DL RX beam indication. Different CSI-RS resources can be received by different UE panels. FIG. 2 provides a multi-TRP scenario with multi-panel UE, where two UE panels are activated for DL reception. DL signals QCLed with CSI-RS resources corresponding to CRI #1-1, CRI #1-2, CRI #1-3 and CRI #1-4 from TRP #1 can only be received by panel #1, and DL signals QCLed with CSI-RS resources corresponding to CRI #2-1, CRI #2-2, CRI #2-3 and CRI #2-4 from TRP #2 can only be received by panel #2. Note that two signals being QCLed (e.g. a DL signal QCLed with a CSI-RS resource) means that the two signals can be received by using a same spatial RX parameter in FR2. A CRI group can be defined to consist of multiple CRIs corresponding to a same UE panel. Then, each UE panel can be identified by the CRI group ID.

For example, in FIG. 2, CRI group #1 can be defined to consist of CRI #1-1, CRI #1-2, CRI #1-3, and CRI #1-4, and CRI group #2 can be defined to consist of CRI #2-1, CRI #2-2, CRI #2-3, and CRI #2-4. Therefore, panel #1 can be identified by ID of CRI group #1, and panel #2 can be identified by ID of CRI group #2.

According to a variety of the first embodiment of identifying a UE panel, IDs of different SSBRI (SS/PBCH block indicator) groups corresponding to different RX panels are used as the panel ID. SSBRIs can be also used for DL RX beam indication. A SSBRI group can be defined to consist of multiple SSBRIs that can be received by a same UE panel. Then, each UE panel can be identified by the SSBRI group ID.

According to a second embodiment of identifying a UE panel, IDs of different SRS resource sets corresponding to different panels are used as the panel ID.

Multi-TRP based PUSCH or PUCCH repetition has been discussed to be supported in NR Release 17 for multi-panel UE in FR2, where a same TB or a same PUCCH resource can be transmitted multiple times by using different UE panels targeting different TRPs in different time slots. Furthermore, it has been agreed that two SRS resource sets used both for codebook based UL transmission or both for non-codebook based UL transmission can be configured to support repetitions of PUSCH transmission for a UE in a BWP. When two panels are activated for UL (e.g. PUSCH) transmission, each SRS resource set of the two SRS resource sets is associated with one UE panel. Accordingly, an SRS resource set ID of the SRS resource sets used for codebook or non-codebook based UL transmission can be used as the panel ID.

According to a third embodiment of identifying a UE panel, IDs of different UL TCI state groups corresponding to different panels are used as panel ID. Unified TCI framework has been discussed to be supported in NR Release 17, where the TX beam for a PUSCH transmission will be directly indicated by the introduced UL TCI field contained in DCI format 0_1 or 0_2 scheduling the PUSCH transmission. One or more UL TCI states (defined in NR Release 17) can be indicated by the UL TCI field of the DCI format 0_1 or 0_2. The UL TCI states corresponding to a same panel can be grouped in a same set (or same group) and be associated with a same index. The ID of the set or the group, or the associated index can be used as the panel ID.

According to a variety of the third embodiment of identifying a UE panel, IDs of different joint TCI state groups corresponding to different panels are used as panel ID. In joint TCI indication, one TCI field contained in DCI format 1_1 or 1_2 can indicate both the UL TCI state and the DL TCI state, also referred to as joint TCI state. The joint TCI states corresponding to a same panel can be grouped in a same set (or same group) or be associated with a same index. The ID of the set or the group, or the associated index or flag can be used as the panel ID.

According to a fourth embodiment of identifying a UE panel, a panel ID is explicitly configured by a new RRC IE (information element), e.g., by a higher layer parameter UE-Panel-Id.

To support panel-specific UL transmission, panel-specific parameters for UL transmission are preferred to be configured per panel, e.g., each higher layer parameter for supporting UL transmission can be associated with the panel ID. For example, each UL TCI state or joint TCI state for PUSCH, SpatialRelationInfo and power control parameters for PUCCH or SRS for different panels should be configured separately, e.g., configured per panel. Furthermore, PUCCH resource or PUCCH resource group, and SRS resource set can be associated with the panel ID for panel-specific transmission.

Take FIG. 2 as an example, if UE-Panel-Id-0 and UE-Panel-Id-1 are explicitly configured for panel #1 and panel #2, all TCI states corresponding to CRI #1-1, CRI #1-2, CRI #1-3 and CRI #1-4 can be associated with UE-Panel-Id-0, and all TCI states corresponding to CRI #2-1, CRI #2-2, CRI #2-3 and CRI #2-4 can be associated with UE-Panel-Id-1. Additionally, for multi-panel multi-TRP PUSCH transmission with repetition, two SRS resource sets used both for codebook based UL transmission (or both for non-codebook based UL transmission) can be configured for a UE in a BWP, wherein each SRS resource set can be associated with a different panel ID (UE-Panel-Id-0 or UE-Panel-Id-1).

### 2. P-MPR Reporting for Multi-Panel UE:

### 2.1. Parameters for P-MPR Reporting for Multi-Panel UE:

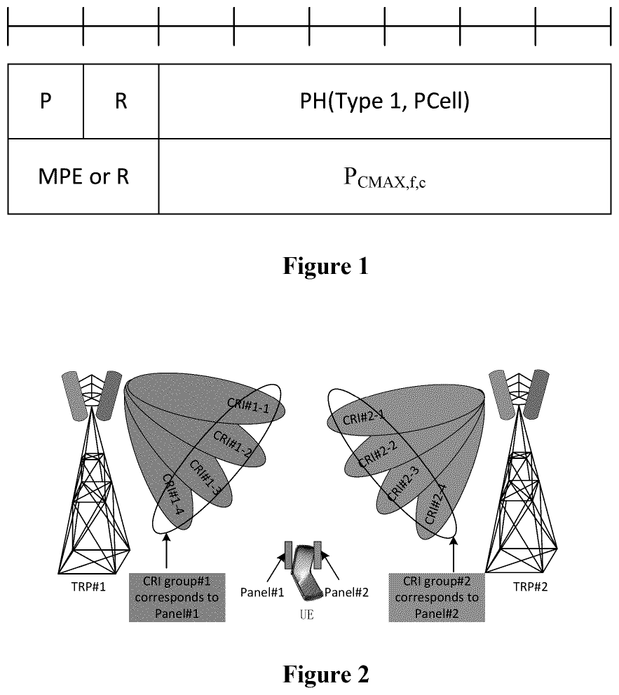

As described in the background part, the absolute P-MPR value for one panel can be reported by the PHR MAC CE illustrated in FIG. 1 when the trigger condition is met (e.g. MPE event is detected). A P-MPR event triggered threshold, i.e., mpe-Threshold, and a prohibit timer, i.e., mpe-ProhibitTimer, which configures a minimum time duration within which P-MPR reporting is prohibited, are configured for the UE with one panel.

In the present disclosure, a multi-panel UE has multiple panels and one or more panels of the multiple panels are activated for UL transmission. Therefore, the event triggered threshold, i.e., mpe-Threshold, can be configured for each panel. In other words, different panels could have different event triggered thresholds. Alternatively, if only one event triggered threshold (mpe-Threshold) is configured for a UE with multiple activated panels, the one event triggered threshold (mpe-Threshold) shall apply to all activated panels.

### 2.2 Condition of P-MPR Triggering:

As described in the background part, P-MPR reporting is triggered when MPE event is detected (for the only one panel).

According to option 1 of the P-MPR triggering condition of the present disclosure, the P-MPR reporting is triggered when MPE event is detected for the activated panel selected for current UL transmission or for the latest UL transmission. Because the activated panel used for current or the latest UL transmission is known for both the UE and the gNB, the gNB knows the panel on which the MPE event happens (i.e. on which the MPE event is detected). Therefore, it is enough to only report the P-MPR value to the gNB. In other words, it is unnecessary to include the panel ID when reporting the P-MPR value. For example, the PHR MAC CE as shown in FIG. 1 can be used for reporting one P-MPR value (without panel ID).

Alternatively, according to option 2 of the P-MPR triggering condition of the present disclosure, the P-MPR reporting is triggered when MPE event is detected on any of the activated panels. The ID of the panel on which the MPE event is detected should be included in the reported PHR MAC CE. This can be implemented, for example, by reporting both the panel ID of the panel on which the MPE event is detected, and the P-MPR value corresponding to the panel on which the MPE event is detected. For example, a ‘panel ID’ field can be added to the PHR MAC CE as shown in FIG. 1.

In addition, according to the option 2, multiple P-MPR values corresponding to multiple panels on each of which the MPE event is detected can be reported together. For example, if two P-MPR values corresponding to two activated panels on each of which MPE event is detected are reported, the two P-MPR values corresponding to the two activated panels and two panel IDs of the two activated panels are reported.

The panel ID can be reported alternatively by a bitmap field contained in the PHR MAC CE. In particular, the bitmap includes a number of bits, where the number is equal to the number of activated panels. Each bit represents one activated panel and indicates whether MPE event is detected on this panel. The bit(s) corresponding to panel(s) on each of which MPE event is detected (i.e. for each of which the P-MPR value is to be reported) can be set to a value (e.g. ‘1’) different from the value (e.g. ‘0’) of the other panel(s) on each of which MPE event is not detected.

It can be seen that option 2 is more flexible compared with option 1, because the gNB can obtain the TX power status for each panel as soon as possible.

### 2.3 Virtual PH (Power Headroom) Reporting:

When multiple panels are activated while MPE event is only detected on one activated panel, it is possible that the panel on which MPE event is detected cannot be used for UL transmission. In this condition, the gNB prefers to quickly know the power status of the other activated panel(s) that can be used for potential UL transmission. According to present disclosure, a virtual PH corresponding to one of the other activated panels (on which MPE event is not detected) can be reported along with the P-MPR reporting.

If MPE event is not detected on one activated panel, the one activated panel is the selected panel for calculating and reporting the virtual PH.

If MPE event is not detected on two or more activated panels, one activated panel on which MPE event is not detected is selected. It is up to UE implementation which panel is selected for calculating and reporting the virtual PH. However, the panel ID for the panel corresponding to the virtual PH report should be reported.

For serving cells configured with PUSCH transmission, the virtual PH is a type-1 PH calculated with a reference PUSCH transmission.

In particular, for PUSCH transmission occasion i on active UL BWP b of carrier f of serving cell c, the type-1 PH using parameter set configuration with index j and PUSCH power control adjustment state with index l is calculated as follows:

PH_{type1,b,f,c}(i,j,q_{d},l)=\tilde{P}_{CMAX,f,c}(i)−{P_{O_PUSCH,b,f,c}(j)+α_{b,f,c}(j)·PL_{b,f,c}(q_{d})+f_{b,f,c}(i,l)} [dB]

wherein, PH_{type1,b,f,c}(i, j, q_{d}, l) is the PH value, \tilde{P}_{CMAX,f,c}(i) is computed assuming MPR=0 dB, A-MPR=0 dB, P-MPR=0 dB, and ΔT_{C}=0 dB, where MPR, A-MPR, P-MPR and ΔT_{C} are defined in TS 38.101-1 V16.3.0, TS 38.101-2 V16.3.0 and TS 38.101-3 V16.3.0; P_{O_PUSCH,b,f,c}(j) and α_{b,f,c}(j) are obtained using P_{O_NORMAL_PUSCH,f,c}(0) and p0-PUSCH-AlphaSetID with the lowest ID associated with the selected panel; PL_{b,f,c}(q_{d}) is obtained using pusch-PathlossReferenceRS-Id with the lowest ID associated with the selected panel; l=0; and f_{b,f,c}(i,l) is the PUSCH power control adjustment state for active UL BWP b of carrier f of serving cell c in PUSCH transmission occasion i.

It can be seen that, in the calculation of the type-1 PH according to the present disclosure, the difference from the legacy calculation lies in that P_{O_PUSCH,b,f,c}(j) and α_{b,f,c}(j) are obtained using P_{O_NORMAL_PUSCH,f,c}(0) and p0-PUSCH-AlphaSetID with lowest ID associated with the selected panel, and that PL_{b,f,c}(q_{d}) is obtained using pusch-PathlossReferenceRS-Id with the lowest ID associated with the selected panel.

For serving cells without PUSCH transmission, the virtual PH is a type-3 PH calculated with a reference SRS transmission.

In particular, the type-3 PH is calculated as follows:

PH_{type3,b,f,c}(i,qₛ)=\tilde{P}_{CMAX,f,c}(i)−{P_{O_SRS,b,f,c}(qₛ)+α_{SRS,b,f,c}(qₛ)·PL_{b,f,c}(q_{d})+h_{b,f,c}(i)} [dB]

where, \tilde{P}_{CMAX,f,c}(i) is computed assuming MPR=0 dB, A-MPR=0 dB, P-MPR=0 dB, and ΔT_{C}=0 dB, where MPR, A-MPR, P-MPR and ΔT_{C} are defined in TS 38.101-1 V16.3.0, TS 38.101-2 V16.3.0 and TS 38.101-3 V16.3.0; qₛ is an SRS resource set corresponding to SRS-ResourceSetId with the lowest ID associated with the selected panel; P_{O_SRS,b,f,c}(qₛ), α_{SRS,f,c}(qₛ), PL_{b,f,c}(q_{d}) are obtained from SRS-ResourceSetId with the lowest ID associated with the selected panel; and h_{b,f,c}(i) is the SRS power control adjustment state for active UL BWP b of carrier f of serving cell c in SRS transmission occasion i.

It can be seen that, in the calculation of the type-3 PH according to the present disclosure, the difference from the legacy calculation lies in that qₛ is an SRS resource set corresponding to SRS-ResourceSetId with the lowest ID associated with the selected panel, and that P_{O_SRS,b,f,c}(qₛ), α_{SRS,f,c}(qₛ), PL_{b,f,c}(q_{d}) are obtained from SRS-ResourceSetId with the lowest ID associated with the selected panel.

The virtual PH may be reported together with the P-MPR value. The panel ID of the panel corresponding to the virtual PH may or may not be reported together with the virtual PH dependent on the number of activated panels. In particular, when the gNB knows the panel corresponding to the virtual PH, it is unnecessary to report the panel ID of the panel corresponding to the virtual PH. For example, in option 1 of the P-MPR triggering condition, the gNB knows the panel on which the MPE event is detected. If the UE only has two panels, the gNB would definite know the panel corresponding to the virtual PH. On the other hand, when the gNB does not know the panel corresponding to the virtual PH, it is necessary to report the virtual PH along with the panel ID of the panel corresponding to the virtual PH.

2.4 Examples of P-MPR reporting for multi-panel UE

A first example is provided as below.

For a typical FR2 UE equipped with three panels, two out of the three panels are activated for DL reception as well as UL transmission. The two activated panels are UE-Panel #1 and UE-Panel #2. Each power control parameter P0-PUSCH-AlphaSet and each power control parameter PUSCH-PathlossReferenceRS are associated with the panel ID. It implies that at least two P0-PUSCH-AlphaSets and at least two PUSCH-PathlossReferenceRSs should be configured. For a UE configured with codebook based UL transmission, four P0-PUSCH-AlphaSets with p0-PUSCH-AlphaSet-Id #0, p0-PUSCH-AlphaSet-Id #1, p0-PUSCH-AlphaSet-Id #2, and p0-PUSCH-AlphaSet-Id #3, and four PUSCH-PathlossReferenceRSs with pusch-PathlossReferenceRS-Id #0, pusch-PathlossReferenceRS-Id #1, pusch-PathlossReferenceRS-Id #2, and pusch-PathlossReferenceRS-Id #3 are configured for the UE in a BWP. Furthermore, p0-PUSCH-AlphaSet-Id #0 and p0-PUSCH-AlphaSet-Id #1, and pusch PathlossReferenceRS-Id #0 and pusch-PathlossReferenceRS-Id #1 are associated with UE-Panel #1, and p0-PUSCH-AlphaSet-Id #2 and p0-PUSCH-AlphaSet-Id #3, and pusch-PathlossReferenceRS-Id #2 and pusch-PathlossReferenceRS-Id #3 are associated with UE-Panel #2.

One event triggered threshold (e.g. mpe-Threshold) and one prohibit timer (e.g. mpe-ProbibitTimer) are configured for the UE and apply to the two activated panels. If option 1 of the P-MPR triggering condition is adopted and UE-Panel #1 is assumed to be used for the latest UL transmission, the P-MPR value reporting corresponding to UE-Panel #1 will be triggered only when MPE event is detected for UE-Panel #1. In addition, a type 1 PH for UE-Panel #2 calculated with a reference PUSCH transmission may be additionally reported along with P-MPR value for UE-Panel #1 for a serving cell configured with PUSCH transmission. The type-1 PH is calculated by

PH_{type1,b,f,c}(i,j,q_{d},l)=\tilde{P}_{CMAX,f,c}(i)−{P_{O_PUSCH,b,f,c}(j)+α_{b,f,c}(j)·PL_{b,f,c}(q_{d})+f_{b,f,c}(i,l)}

wherein, \tilde{P}_{CMAX,f,c}(i) is computed assuming MPR=0 dB, A-MPR=0 dB, P-MPR=0 dB, and ΔT_{C}=0 dB, where MPR, A-MPR, P-MPR and ΔT_{C} are defined in TS 38.101-1 V16.3.0, TS 38.101-2 V16.3.0 and TS 38.101-3 V16.3.0; P_{O-PUSCH,b,f,c}(j) and α_{b,f,c}(j) are obtained using P_{O_NORMAL_PUSCH,f,c}(0) and p0-PUSCH-AlphaSetID=2; PL_{b,f,c}(q_{d}) is obtained using pusch-PathlossReferenceRS-Id=2; l=0; f_{b,f,c}(i,l) is the PUSCH power control adjustment state for active UL BWP b of carrier f of serving cell c in PUSCH transmission occasion i.

A second example is provided as below.

In the second example, the UE has the same panel configuration as in the first example. That is, the UE is equipped with three panels; and two out of the three panels are activated for DL reception as well as UL transmission. The two activated panels are UE-Panel #1 and UE-Panel #2. Each SRS resource set is associated with a panel ID. For example, SRS resource sets with SRS-ResourceSet-Id #0, SRS-ResourceSet-Id #1, SRS-ResourceSet-Id #2, SRS-ResourceSet-Id #3, SRS-ResourceSet-Id #4, SRS-ResourceSet-Id #5, SRS-ResourceSet-Id #6, and SRS-ResourceSet-Id #7 are associated with UE-Panel #1, and SRS resource sets with SRS-ResourceSet-Id #8, SRS-ResourceSet-Id #9, SRS-ResourceSet-Id #10, SRS-ResourceSet-Id #11, SRS-ResourceSet-Id #12, SRS-ResourceSet-Id #13, SRS-ResourceSet-Id #14, and SRS-ResourceSet-Id #15 are associated with UE-Panel #2. If option 2 of the P-MPR triggering condition is adopted, and UL-Panel #1 is assumed to be selected for the latest UL transmission while MPE event is detected on UL-Panel #2, the P-MPR value corresponding to UL-Panel #2 is reported. In order to report the panel ID corresponding to the reported P-MPR, a bitmap with a length of 2 bits (e.g. P₁ corresponds to UL-Panel #1, P₂ corresponds to UL-Panel #2) is included in the PHR MAC CE (used for P-MPR reporting). Pᵢ (i=1 or 2) is set to for example 1 indicating that the reported P-MPR corresponds to UL-Panel #i. For example, when the reported P-MPR corresponds to UL-Panel #2, P₂=1 and P₁=0.

Furthermore, a type 3 PH for UL-Panel #1 may be additionally reported along with the P-MPR reporting corresponding to UL-Panel #2 for a serving cell without PUSCH transmission. The type 3 PH is calculated by

PH_{type3,b,f,c}(i,qₛ)=\tilde{P}_{CMAX,f,c}(i)−{P_{O_SRS,b,f,c}(qₛ)+α_{SRS,b,f,c}(qₛ)·PL_{b,f,c}(q_{d})+h_{b,f,c}(i)}

wherein, \tilde{P}_{CMAX,f,c}(i) is computed assuming MPR=0 dB, A-MPR=0 dB, P-MPR=0 dB, and ΔT_{C}=0 dB, where MPR, A-MPR, P-MPR and ΔT_{C} are defined in TS 38.101-1 V16.3.0, TS 38.101-2 V16.3.0 and TS 38.101-3 V16.3.0; qₛ is the SRS resource set corresponding to SRS-ResourceSetId=0; P_{O_SRS,b,f,c}(qₛ), α_{SRS,f,c}(qₛ), PL_{b,f,c}(q_{d}) are obtained from SRS-ResourceSetId=0; h_{b,f,c}(i) is the SRS power control adjustment state for active UL BWP b of carrier f of serving cell c in SRS transmission occasion i.

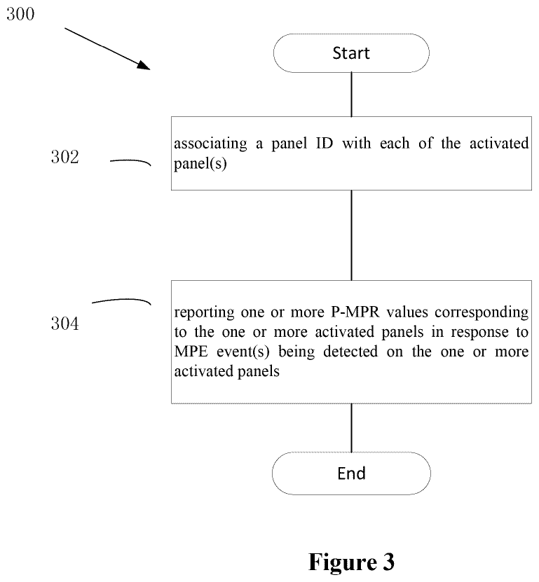

FIG. 3 is a schematic flow chart diagram illustrating an embodiment of a method 300 according to the present application. In some embodiments, the method 300 is performed by an apparatus, such as a remote unit (e.g. UE). In certain embodiments, the method 300 may be performed by a processor executing program code, for example, a microcontroller, a microprocessor, a CPU, a GPU, an auxiliary processing unit, a FPGA, or the like.

The method 300 is a method of a UE, wherein the UE has multiple panels, and one or more of the multiple panels are activated. The method 300 may include 302 associating a panel ID with each of the activated panel(s); and reporting one or more P-MPR values corresponding to the one or more activated panels in response to MPE event(s) being detected on the one or more activated panels.

In one embodiment, in response to the MPE event being detected on the activated panel selected for current UL transmission or for the latest UL transmission, only one P-MPR value is reported.

In another embodiment, in response to the MPE event being detected on any of the activated panels that can be used for UL transmission, P-MPR value(s) corresponding to all activated panel(s) on each of which the MPE event is detected are reported. In this condition, the method may further comprise reporting panel ID(s) of the activated panel(s) on each of which the MPE event is detected. The Panel ID(s) may be represented by a bitmap contained in a MAC CE containing the P-MPR value(s), and each bit of the bitmap indicates whether the P-MPR corresponding to the represented panel is reported.

The method may further comprise reporting a power headroom for an activated panel on which the MPE event is not detected. The power headroom may be a type-1 PH calculated with a reference PUSCH transmission for the activated panel on which the MPE event is not detected for a UL cell with PUSCH transmission. In the calculation of the type-1 PH, P_{O-PUSCH,b,f,c}(j) and α_{b,f,c}(j) are obtained using P_{O_NORMAL_PUSCH,f,c}(0) and p0-PUSCH-AlphaSetID with the lowest ID associated with the activated panel on which the MPE event is not detected, and PL_{b,f,c}(q_{d}) is obtained using pusch-PathlossReferenceRS-Id with the lowest ID associated with the activated panel on which the MPE event is not detected. The power headroom may alternatively be a type-3 PH calculated with a reference SRS transmission for the activated panel on which the MPE event is not detected for a UL cell without PUSCH transmission. In the calculation of the type-3 PH, qₛ is an SRS resource set corresponding to SRS-ResourceSetId with lowest ID associated with the the activated panel on which the MPE event is not detected, P_{O_SRS,b,f,c}(qₛ), α_{SRS,f,c}(qₛ), PL_{b,f,c}(q_{d}) are obtained from SRS-ResourceSetId with lowest ID associated with the activated panel on which the MPE event is not detected.

The panel ID may be identified by a CRI group ID, an SSBRI group ID, an SRS resource set ID, an UL TCI state group ID, or a joint TCI state group ID. In addition, the method may further comprise associating any of panel-specific parameters for UL transmission with the panel ID.

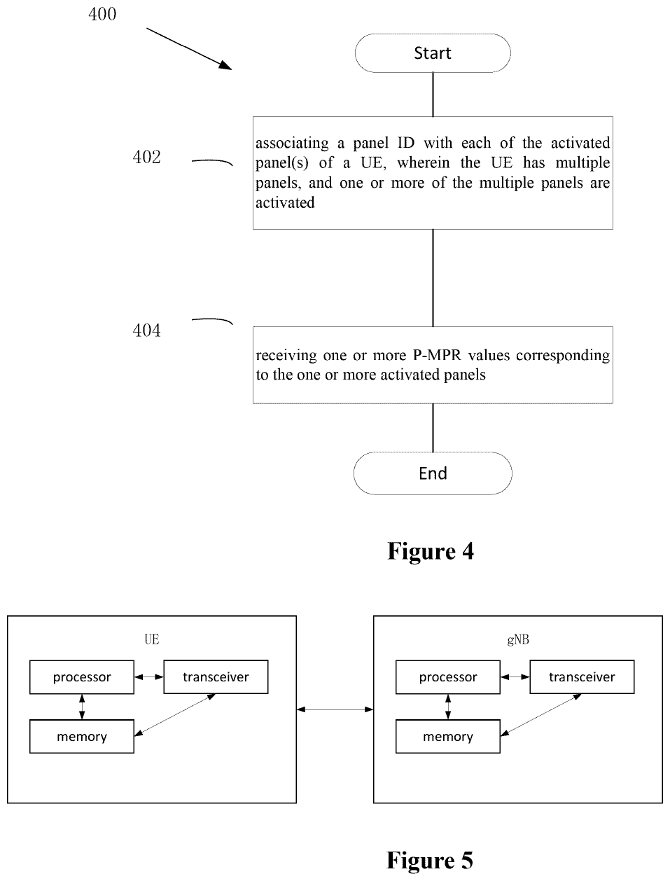

FIG. 4 is a schematic flow chart diagram illustrating an embodiment of a method 400 according to the present application. In some embodiments, the method 400 is performed by an apparatus, such as a base unit. In certain embodiments, the method 400 may be performed by a processor executing program code, for example, a microcontroller, a microprocessor, a CPU, a GPU, an auxiliary processing unit, a FPGA, or the like.

The method 400 may include 402 associating a panel ID with each of the activated panel(s) of a UE, wherein the UE has multiple panels, and one or more of the multiple panels are activated; and 404 receiving one or more P-MPR values corresponding to the one or more activated panels. It is assumed that MPE event is detected on each of the activated panels.

In an embodiment, one P-MPR value is received. It is assumed that the one P-MPR value corresponds to the activated panel on which the MPE event is detected, and that the activated panel is selected for current UL transmission or for the latest UL transmission.

In another embodiment, P-MPR value(s) corresponding to one or more activated panel(s) are received. It is assumed that the MPE event is detected on the one or more activated panel(s). In this condition, the method may further comprise receiving panel ID(s) of the activated panel(s). The Panel ID(s) may be represented by a bitmap contained in a MAC CE containing the P-MPR value(s), and each bit of the bitmap indicates whether the P-MPR corresponding to the represented panel is received.

The method may further comprise receiving a power headroom for an activated panel on which the MPE event is not detected. The power headroom may be a type-1 PH calculated with a reference PUSCH transmission for the activated panel on which the MPE event is not detected for a UL cell with PUSCH transmission. In the calculation of the type-1 PH, P_{O-PUSCH,b,f,c}(j) and α_{b,f,c}(j) are obtained using P_{O_NORMAL_PUSCH,f,c}(0) and p0-PUSCH-AlphaSetID with the lowest ID associated with the activated panel on which the MPE event is not detected, and PL_{b,f,c}(q_{d}) is obtained using pusch-PathlossReferenceRS-Id with the lowest ID associated with the activated panel on which the MPE event is not detected. The power headroom may alternatively be a type-3 PH calculated with a reference SRS transmission for the activated panel on which the MPE event is not detected for a UL cell without PUSCH transmission. In the calculation of the type-3 PH, qₛ is an SRS resource set corresponding to SRS-ResourceSetId with lowest ID associated with the the activated panel on which the MPE event is not detected, P_{O_SRS,b,f,c}(qₛ), α_{SRS,f,c}(qₛ), PL_{b,f,c}(q_{d}) are obtained from SRS-ResourceSetId with lowest ID associated with the activated panel on which the MPE event is not detected.

The panel ID may be identified by a CRI group ID, an SSBRI group ID, an SRS resource set ID, an UL TCI state group ID, or a joint TCI state group ID. In addition, the method may further comprise associating any of panel-specific parameters for UL transmission with the panel ID.

FIG. 5 is a schematic block diagram illustrating apparatuses according to one embodiment.

Referring to FIG. 5, the UE (i.e. the remote unit) includes a processor, a memory, and a transceiver. The processor implements a function, a process, and/or a method which are proposed in FIG. 3.

The UE has multiple panels, wherein one or more of the multiple panels are activated. The UE comprises a processor that associates a panel ID with each of the activated panel(s); and a transmitter that reports one or more P-MPR values corresponding to the one or more activated panels in response to MPE event(s) being detected on the one or more activated panels.

In one embodiment, in response to the MPE event being detected on the activated panel selected for current UL transmission or for the latest UL transmission, only one P-MPR value is reported.

In another embodiment, in response to the MPE event being detected on any of the activated panels that can be used for UL transmission, P-MPR value(s) corresponding to all activated panel(s) on each of which the MPE event is detected are reported. In this condition, the transmitter may further report panel ID(s) of the activated panel(s) on each of which the MPE event is detected. The Panel ID(s) may be represented by a bitmap contained in a MAC CE containing the P-MPR value(s), and each bit of the bitmap indicates whether the P-MPR corresponding to the represented panel is reported.

The transmitter may further report a power headroom for an activated panel on which the MPE event is not detected. The power headroom may be a type-1 PH calculated with a reference PUSCH transmission for the activated panel on which the MPE event is not detected for a UL cell with PUSCH transmission. In the calculation of the type-1 PH, P_{O-PUSCH,b,f,c}(j) and α_{b,f,c}(j) are obtained using P_{O_NORMAL_PUSCH,f,c}(0) and p0-PUSCH-AlphaSetID with the lowest ID associated with the activated panel on which the MPE event is not detected, and PL_{b,f,c}(q_{d}) is obtained using pusch-PathlossReferenceRS-Id with the lowest ID associated with the activated panel on which the MPE event is not detected. The power headroom may alternatively be a type-3 PH calculated with a reference SRS transmission for the activated panel on which the MPE event is not detected for a UL cell without PUSCH transmission. In the calculation of the type-3 PH, qₛ is an SRS resource set corresponding to SRS-ResourceSetId with lowest ID associated with the the activated panel on which the MPE event is not detected, P_{O_SRS,b,f,c}(qₛ), α_{SRS,f,c}(qₛ), PL_{b,f,c}(q_{d}) are obtained from SRS-ResourceSetId with lowest ID associated with the activated panel on which the MPE event is not detected.

The panel ID may be identified by a CRI group ID, an SSBRI group ID, an SRS resource set ID, an UL TCI state group ID, or a joint TCI state group ID. In addition, the processor may further associate any of panel-specific parameters for UL transmission with the panel ID.

The gNB (i.e. the base unit) includes a processor, a memory, and a transceiver. The processor implements a function, a process, and/or a method which are proposed in FIG. 4.

The base unit comprises a processor that associates a panel ID with each of the activated panel(s) of a UE, wherein the UE has multiple panels, and one or more of the multiple panels are activated; and a receiver that receives one or more P-MPR values corresponding to the one or more activated panels. It is assumed that MPE event is detected on each of the activated panels.

In an embodiment, the receiver receives one P-MPR value. It is assumed that the one P-MPR value corresponds to the activated panel on which the MPE event is detected, and that the activated panel is selected for current UL transmission or for the latest UL transmission.

In another embodiment, the receiver receives P-MPR value(s) corresponding to one or more activated panel(s). It is assumed that the MPE event is detected on the one or more activated panel(s). In this condition, the receiver may further receive panel ID(s) of the activated panel(s). The Panel ID(s) may be represented by a bitmap contained in a MAC CE containing the P-MPR value(s), and each bit of the bitmap indicates whether the P-MPR corresponding to the represented panel is received.

The receiver may further receives a power headroom for an activated panel on which the MPE event is not detected. The power headroom may be a type-1 PH calculated with a reference PUSCH transmission for the activated panel on which the MPE event is not detected for a UL cell with PUSCH transmission. In the calculation of the type-1 PH, P_{O-PUSCH,b,f,c}(j) and α_{b,f,c}(j) are obtained using P_{O_NORMAL_PUSCH,f,c}(0) and p0-PUSCH-AlphaSetID with the lowest ID associated with the activated panel on which the MPE event is not detected, and PL_{b,f,c}(q_{d}) is obtained using pusch-PathlossReferenceRS-Id with the lowest ID associated with the activated panel on which the MPE event is not detected. The power headroom may alternatively be a type-3 PH calculated with a reference SRS transmission for the activated panel on which the MPE event is not detected for a UL cell without PUSCH transmission. In the calculation of the type-3 PH, qₛ is an SRS resource set corresponding to SRS-ResourceSetId with lowest ID associated with the the activated panel on which the MPE event is not detected, P_{O_SRS,b,f,c}(qₛ), α_{SRS,f,c}(qₛ), PL_{b,f,c}(q_{d}) are obtained from SRS-ResourceSetId with lowest ID associated with the activated panel on which the MPE event is not detected.

The panel ID may be identified by a CRI group ID, an SSBRI group ID, an SRS resource set ID, an UL TCI state group ID, or a joint TCI state group ID. In addition, the processor may further associate any of panel-specific parameters for UL transmission with the panel ID.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated in the appended claims rather than by the foregoing description. All changes which come within the meaning and range of equivalency of the claims are to be embraced within their scope.

1. A user equipment (UE), wherein the UE has multiple panels, and wherein one or more of the multiple panels are activated, the UE comprising:
a processor; and
a memory coupled with the processor, wherein the processor is configured to cause the UE to:
associate a panel ID with each of the one or more activated panels; and
report one or more Power Management Maximum Power Reduction (P-MPR) values corresponding to the one or more activated panels in response to Maximum Permissible Exposure (MPE) events being detected on the one or more activated panels.

2. The UE of claim 1, wherein, in response to an MPE event being detected on an activated panel selected for current uplink (UL) transmission or for a latest UL transmission, the processor is further configured to cause the UE to:
only report one P-MPR value.

3. The UE of claim 1, wherein, in response to an MPE event being detected on any panel of the one or more activated panels that can be used for UL transmission, the processor is further configured to cause the UE to report P-MPR values corresponding to all activated panels on which the MPE event is detected.

4. The UE of claim 3, wherein the processor is further configured to cause the UE to:
report panel IDs of the one of more activated panels on which the MPE event is detected.

5. The UE of claim 4, wherein the panel IDs are represented by a bitmap contained in a Medium Access Control Control Element (MAC CE) containing the P-MPR values, wherein each bit of the bitmap indicates whether the P-MPR value corresponding to the represented panel ID is reported.

6. The UE of claim 1, wherein the processor is further configured to cause the UE to:
report a power headroom for an activated panel on which an MPE event is not detected.

7. The UE of claim 6, wherein the power headroom is a type-1 power headroom (PH) calculated with a reference Physical Uplink Shared Channel (PUSCH) transmission for the activated panel on which the MPE event is not detected for an Uplink (UL) cell with PUSCH transmission.

8. The UE of claim 7, wherein, in the calculation of the type-1 PH, P_{O-PUSCH,b,f,c}(j) and α_{b,f,c}(j) are obtained using P_{O_NORMAL_PUSCH,f,c}(0) and p0-PUSCH-AlphaSetID with the lowest ID associated with the activated panel on which the MPE event is not detected, and PL_{b,f,c}(q_{d}) is obtained using pusch-PathlossReferenceRS-Id with the lowest ID associated with the activated panel on which the MPE event is not detected.

9. The UE of claim 6, wherein, the power headroom is a type-3 PH calculated with a reference Sounding Reference Signal (SRS) transmission for the activated panel on which the MPE event is not detected for an Uplink (UL) cell without Physical Uplink Shared Channel (PUSCH) transmission.

10. The UE of claim 9, wherein, in the calculation of the type-3 PH, qₛ is an SRS resource set corresponding to SRS-ResourceSetId with lowest ID associated with the activated panel on which the MPE event is not detected, and P_{O_SRS,b,f,c}(qₛ), α_{SRS,f,c}(qₛ), and PL_{b,f,c}(q_{d}) are obtained from SRS-ResourceSetId with lowest ID associated with the activated panel on which the MPE event is not detected.

11. The UE of claim 1, wherein the panel ID is identified by a CSI-RS Resource indicator (CRI) group ID, an SS/PBCH Block Indication (SSBRI) group ID, a Sounding Reference Signal (SRS) resource set ID, an Uplink (UL) Transmission Configuration Indication (TCI) state group ID, or a joint TCI state group ID.

12. The UE of claim 1, wherein the processor is further configured to cause the UE to:
associate panel-specific parameters for Uplink (UL) transmission with the panel ID.

13.-15. (canceled)

16. A method performed by a user equipment (UE), wherein the UE has multiple panels, and wherein one or more of the multiple panels are activated, the method comprising:
associating a panel ID with each of the one or more activated panels; and
reporting one or more Power Management Maximum Power Reduction (P-MPR) values corresponding to the one or more activated panels in response to Maximum Permissible Exposure (MPE) events being detected on the one or more activated panels.

17. The method of claim 16, further comprising:
causing the UE to only report one P-MPR value in response to an MPE event being detected on an activated panel selected for current uplink (UL) transmission or selected for a latest UL transmission.

18. The method of claim 16, further comprising:
causing the UE to report P-MPR values corresponding to all activated panels on which the MPE event is detected in response to an MPE event being detected on any panel of the one or more activated panels that can be used for UL transmission.

19. The method of claim 16, further comprising:
reporting panel IDs of the one of more activated panels on which the MPE event is detected.

20. The method of claim 16, wherein the panel ID is identified by a CSI-RS Resource indicator (CRI) group ID or an SS/PBCH Block Indication (SSBRI) group ID.

21. A processor for wireless communication, the processor comprising:
at least one controller coupled with at least one memory and configured to cause the processor to:
associate a panel ID with one or more activated panels of a user equipment (UE) having multiple panels; and
report one or more Power Management Maximum Power Reduction (P-MPR) values corresponding to the one or more activated panels in response to Maximum Permissible Exposure (MPE) events being detected on the one or more activated panels.

22. The processor of claim 21, wherein the panel ID is identified by a CSI-RS Resource indicator (CRI) group ID or an SS/PBCH Block Indication (SSBRI) group ID.

23. The processor of claim 21, wherein the controller is further configured to cause the processor to report panel IDs of the one of more activated panels on which the MPE event is detected.
